(19) United States
(12) Patent Application Publication
(10) Pub. No.: US 2008/0085971 A1
(43) Pub. Date: Apr. 10, 2008

(54) Polymer Mixtures for Injection-Molding Applications

(76) Inventors: Rolf Muller, Zurich (CH); Federico Innerebner, Zurich (CH)

Correspondence Address: BACHMAN & LAPOINTE, P.C., 900 CHAPEL STREET, SUITE 1201, NEW HAVEN, CT, 06510, US

(21) Appl. No.: 11/577,250

(22) PCT Filed: Oct. 19, 2005
(86) PCT No.: PCT/CH05/00611

§ 371 Date: Oct. 29, 2007

(30) Foreign Application Priority Data
Oct. 19, 2004 (DE) 10 2004 051 093.8

(51) Int. Cl. C08L 23/00

(52) U.S. Cl. 524/488; 524/487

(57) ABSTRACT

Molded part comprised of a polymer mixture, wherein a) the polymer mixture exhibits a synthetic first polymer P(i) and at least a second synthetic polymer P(j), that b) polymer P(i) exhibits a polymerization degree DP(P(i))>400 and at least one type of crystallizable sequences A with a polymerization degree DPs(P(i)) of these sequences of >15, that c) the polymer P(j) consists of the same monomer units as the sequences A of P(i), the polymerization degree DP(P(j)) of P(j) is <400, that d) the polymer mixture is mixed in a molecularly disperse manner, and a phase separation of the two polymers P(i) and P(j) is suppressed, and that e) the polymer mixture is shaped into a molded part by means of an injection molding process, wherein f) a network is formed during the solidification of the polymer mixture during heterocrystallization, characterized in that g) the percentage of p(j) at a polymerization degree of <12 in % w/w is <20.

The invention relates to polymer mixtures used in injection molding, which enable reduced cycle times, and hence increased efficiency, owing to a tangibly improved flow and higher crystallization rate. The mechanical properties of the injection-molded parts are also improved in the process.

### BRIEF DESCRIPTION OF THE INVENTION AND PRIOR ART

The productivity, and hence efficiency, of injection molding processes is determined primarily by cycle time. The cycle times can be affected by the parameters of the injection-molding tool, e.g., its heating and cooling capacity, as well as by the selected polymer. The heating and cooling capacity of injection molding tools has today been increased to optimal levels. However, these parameters cannot be maximized independently of the used polymer, since too high a cooling capacity will negatively impact the product properties. The modulus of elasticity and yield point of PE-injection molded parts, for example, clearly decreases as the cooling rate increases. Selecting a polymer with a high MFI (melt flow index) makes it possible to reduce the injection and molding temperature owing to the improved flow, so that the cycle time can also be cut. However, such high MFI polymers with good material properties are generally more expensive than commodity low MFI polymers. A high MFI is obtained by way of a low MFI. Since the mechanical properties typically diminish with decreasing molecular weight, restrictions are also imposed here relative to the selection of polymers with low MFI limits. Another option is to use flow aids, which are incorporated into the injection-molding compound as additives. The share of these low-molecular and low-viscous additives typically lies at 1%, since higher concentrations impair the properties of the injection-molded products. As a result, any reduction in cycle time is highly limited during the use of such additives.

The invention describes a new way of distinctly reducing the cycle times through the use of suitable polymer mixtures, which have at least two synthetic components P(i) and P(j). As a result, the efficiency of the injection molding process can be significantly improved. Use is here made of a polymer mixture that has a low-molecular percentage with the waxy polymer P(j), which synergistically interacts with the high-molecular polymer P(i). As long as the polymer mixture is present as a melt, the low-molecular polymer P(j) reduces the viscosity, or the MFI is increased, so that the cycle time can be decreased. In the cooling process, both components are then simultaneously crystallized, synergistically yielding mixed crystallites or heterocrystallites of P(i) and P(j). Therefore, the low-molecular polymer P(j) is incorporated into the lattice of the macromolecular network of the polymer P(i), in so doing to some extent becoming a macromolecular polymer. This is why the MFI can be reduced without the disadvantages of reduced mechanical properties otherwise commonly encountered when using a low-molecular polymer. Quite the opposite is true, since even the mechanical properties of the injection-molded part are improved by using a P(j) that crystallizes very readily, because this also induces an improved crystallizability of P(i). This in turn enables faster cooling times. As opposed to the previous additives, which could only be used in increments of 1%, this makes it possible to use much higher contents of P(j) ranging from 3 to 30%, enabling a much more pronounced rise in the MFI, and a correspondingly more tangible reduction in the cycle times. Typically, [sic].

In order to achieve these advantages, the two polymers P(i) and P(j) must be tailored to each other in terms of structural preconditions and mixed together in the melt in a molecularly disperse manner, and separation prior to crystallization must be prevented, since separation into two separate phases represents the stable state at thermodynamic equilibrium for polymers with clearly different molecular weights, as is the case for P(i) and P(j). This is possible given the use of suitable polymer mixtures and suitable process implementation, even at P(j) contents up to and exceeding 30%.

This invention is a further development of Patent Application WO 2004/09228 of the same applicant, the disclosure of which is hereby incorporated in this invention.

Patent Publication US 2002/0045022 A1 describes screwed plugs for bottles that can be fabricated in an injection molding process, and exhibit 0.01 to 1% w/w of an additive in addition to a polymer, so that the sliding properties of the screwed caps can be improved. The additive can be natural lignite or Montan wax, or a polar polyolefin or paraffin wax. However, the lignite and Montan waxes are not synthetic in origin like the low-molecular P(j) of this invention, and the polar waxes are not compatible with the polymer in terms of this invention due to the polar groups, since they cannot form mixed crystallites with them because of the polar groups. The additives are also incorporated in lower percentages and not to optimize the injection-molding process, but rather to improve the surface friction of the caps.

Patent Publication US 2004/0030287 A1 describes a plastic syringe manufactured via injection molding, which is based on polypropylene and contains up to 10% of a polyethylene wax. The wax is used to improve the sliding characteristics here as well, and polypropylene and polyethylene wax are not compatible in terms of this invention, even in cases where the polypropylene can exhibit up to 5% ethylene units as described in the publication, since this invention requires a block arrangement of the ethylene units with a length of at least 15 units, while the ethylene units in the publication are preferably randomly arranged. Since the wax is used to improve the sliding properties, the formation of mixed crystallites is not part of the publication, since the wax would then be bound in crystallites, and could no longer contribute to improving the sliding properties.

### DETAILED DESCRIPTION OF INVENTION

This invention describes the necessary preconditions relative to the structural sizes of P(i) and P(j), as well as the conditions for manufacturing suitable mixtures thereof, so that these two polymers can advantageously crystallize synergistically during heterocrystallization, during which the very readily crystallizable P(j) owing to the short chain length induces crystallinity for P(i), and gives rise to a network, the linkage points of which are mixed or heterocrystallites of P(i) and P(j), and the linkage elements of which consist of chain segments of P(i). Under suitable production conditions, the mixture of P(i) and P(j) can yield a material which, by comparison to P(i), has a higher crystallinity, a higher modulus of elasticity, a higher yield point, a comparable breaking elongation and a comparable to improved impact strength, as well as an improved stress cracking resistance, while the viscosity of the melt is distinctly reduced, or the MFI is distinctly elevated, so that the melt can be more easily processed, in particular making it possible to significantly reduce the cycle time in the injection molding process.

The increase in MFI with the content of P(j) is depicted on FIG. 1 for three different P(i). The top and bottom curve indicate the range within which a curve progression lies for conventional injection molding polymers during the use of P(j). In light of the distinctly elevated MFI of P(i)+P(i) relative to the MFI of P( ), an entire range of improvements becomes possible during injection molding. The melt can be injected into the mold at a lower injection temperature and lower pressure, the mold filling capacity is improved, the mold does not have to be heated as intensely, shorter holding pressure times are possible, and the mold can be cooled faster, since P(i)+P(j) crystallizes faster than P(i), and fewer frozen stresses come about that can subsequently lead to crack formation or stress cracking. All told, these improvements result in a reduction in cycle time during the injection molding process, making it possible to significantly improve efficiency.

FIG. 2 shows the effect of an increased MFI for P(i)+P(j) relative to the MFI for P(i) on cycle time, wherein the top and bottom curve denote the scatter range, and the middle curve describes an average case. The curves were determined based on known values relating to cycle times for polymers with varying MFI and by means of model calculations. The scatter range encompasses small injection molding parts ranging from several grams up to large segments of several kilos and more, along with various geometries and wall thicknesses. The cycle time for the mixture of P(i)+P(j) is reduced by comparison to the cycle time for P(j) by >7%, preferably >15%, more preferably >25%, and most preferably >30% and at most 70%.

While the principle underlying this invention is here outlined for polyolefins, it can also be applied analogously to other polymers.

### P(i)

The first polymer P(i) is any synthetic polymer with a polymerization degree DP>400, which has at least a minimal crystallinity. It can both be linear, and exhibit short and long-chain branches. It can be a homopolymer, a copolymer, a terpolymer or a higher polymer, provided that at least one type of varying monomer units are at least partially arranged in sequences. One sequence is here understood to be a section of polymer that is made up of the same monomer units or a regular sequence of monomer units, and of at least 15 such units (i.e., the polymerization degree of repeating units in the sequences DPs is about >15), has neither short nor long chain branches, and exhibits the preconditions for the crystallization of such sequences for this section, even with respect to conformation. One sequence can be situated in the primary chain and/or in a side chain, or even be a side chain. When cooled out of the melt, such polymers exhibit at least a minimal crystallinity.

In order that effective bonds can be formed between the mixed crystallites, the polymerization degree of P(i), DP(P(i))>400, preferably >700, more preferably >1500, and most preferably >3000.

The polymerization degree for the crystallizable sequences of P(i), DPs(P(i)) is >15, preferably >20, more preferably >30, and most preferably >50. As DPs(P(i)) increases, so too do the crystallinity of P(i) and the melting point Tm of these crystallites. The tendency to form mixed crystallites with P(j) also rises.

Basically all polymers that satisfy the mentioned conditions can be used for P(i). In one enumeration not to be construed as limiting, this includes the crystallizable sequences of the polyolefin polymers, e.g., PP and PE, in particular HDPE, HMWPE, UHMPE, LDPE, LLDPE, VLDPE, as well as ABS, PUR, PET, PVC.

In particular injection-molding types of these polymers can be used, wherein the injectability and overall performance can be significantly improved by adding a percentage of P(j). Adding 10 to 15% P(j) typically doubles the MFI. Depending on the polymer, the increase in MFI in this amount of P(J) can range from 50 to 600%. At 20% P(j), the MFI can even be increased by in excess of 1000%.

To enable a synergistic effect between P(j) and the crystallizable sequences of P(i), the mass ratio between these sequences and P(j) must be >1, preferably >2.5, more preferably >5, and most preferably >10, in the case of block copolymers or higher polymers.

Injectable polymers are then characterized by a high MFI. The previous ways for improving the MFI, and hence injectability, are limited and/or require the use of high-quality and expensive polymers, as mentioned at the outset. By contrast, adding a percentage of P(j) not only improves the injectability of injection-molding polymers, but even sparingly injectable or uninjectable polymers can be used, making it possible to use favorable polymers with good material properties. Such polymers otherwise require very high injection and molding temperatures, wherein significant thermal degradation sets in. The massive increase in MFI attained by admixing P(j) makes it possible to decrease these temperatures typically up to around 50° C., or even lower given high percentages of P(j). A sparingly injectable PE exhibits an MFI ranging from 0.3 g/10 min at 190° C. and 2.16 kg. When adding 20% P(j), the MFI can be raised by a factor of 10 to 3 g/10 min, which is characteristic for a readily injectable PE. On the other hand, such a PE can be brought to a level of 30 g/10 min, a value that characterizes an extremely light injectability, and can hardly be reached using conventional PE. Surprisingly, this can be achieved without impairing the material properties, which can even be improved.

Due to the very small percentage of side chains of roughly only 2 per 1000 C atoms in the chain, typical injection-molding HDPE's are very readily crystallizable. Therefore, it is all the more surprising that the mechanical properties can be improved by adding P(j), even for HDPE. This can be attributed to the fact that the melt exhibits a reduced viscosity during crystallization owing to a percentage of P(j), thus facilitating the course of rearrangement processes of the macromolecules, yielding an elevated crystallinity and a reduction in crystallite defects. As also evident from the above, the positive effects of a percentage of P(j) are most pronounced as the cooling rate increases.

### P(j)

The second synthetic polymer P(j) is either linear or nearly linear (P(j)1), and then essentially consists of a sequence assembled from the same monomer units as the sequences of polymer P(i). Synthetic is here understood to mean “not of biological origin”, and hence encompasses synthetic polymers in a narrower sense, along with polymers of a mineral origin. On the other hand, the polymer P(j) can also exhibit branches, or even be hyper-branched (P(j)2), wherein the side chains are assembled from the same monomer units as the sequences of polymer P(i), and have a chain length of >15.

If P(j)1 is cooled out of the melt or precipitated from a solution, crystallites are obtained, wherein the macromolecules of P(j)1 present in stretched conformation usually form lamellae, so that the lamellar thickness is identical to the length of the macromolecules P(j)1. Since hardly any bonds exist between the lamellae in the form of macromolecules incorporated into at least two lamellae, the content of these lamellae is minimal, and the mechanical properties of such crystal agglomerates, in particular strength and breaking elongation, are low, despite the high crystallinity. The situation relative to sequences for P(j)2 is comparable to that for P(j)1, but different branches of P(j)2 can be incorporated into various mixed crystallites, enabling linkages between mixed crystallites not just via P(i), but also via P(j)2, so that the network can be strengthened as a result. While the invention will be described relative to P(j)1 for the sake of clarity below, the discussion can also be applied analogously to P(j)2, wherein the conditions for P(j)1 then apply with respect to the side chains and segments of P(j)2. The use of second P(j)2 type polymers makes sense, in that the number of linkages between heterocrystallites can be increased in this way, and particularly narrow-meshed networks are formed. In the presence of a swelling agent, this makes it possible to influence the degree of swelling, for example, in particular reduce it.

The polymerization degree of P(j), DP(P(j)), is >15, preferably >20, more preferably >25, and most preferably >30, wherein the polymerization degree is here also understood as the number of smallest repeating units. The polymerization degree is usually distributed; polymerization degree is here understood as the numerical average. The viscosity of the P(j) melt increases with polymerization degree, so that the lowest possible polymerization degrees are optimal with respect to a maximal increase in the MFI. On the other hand, the trend toward separation also increases as polymerization degree decreases, so that higher polymerization degrees are advantageous in this regard. The optimal selection depends on the type of injection-molded part, wherein separation processes are suppressed in the case of thin-walled parts, where high cooling rates prevail, and P(j) with the lowest molecular weights can be used; in thick-walled parts, P(j) with higher molecular weights are preferred, in particular if remelting takes place. A higher molecular weight is also preferred when high impact strengths are required. The maximum polymerization degree DP(P(j)) is <400, preferably <300, even more preferably <200, and most preferably <150. A good compromise with respect to increased MFI, separation stability and high impact strength is enabled at polymerization degrees ranging form 30 to 110.

It was found that the synergistic effects of P(i) and linear P(j) distinctly increase as the polydispersity of the molecular weight distribution of P(j) tapers off. Polydispersity is defined as the quotient of the average weight and numerical average of the molecular weight distribution, and can measure a minimum of 1, if all molecules are exactly the same length. Therefore, narrow molecular weight distributions are advantageous. This has to do with the fact that, in ideal cases of equally long P(j), lamellar crystallites are formed vary easily, with the P(j) chains being present in stretched conformation. In this case, the lamellar thickness corresponds precisely to the chain length of P(j). Longer or shorter chains hamper crystallization, and reduce crystallite stability. Polydispersity has little influence in increased MFI, but the mechanical properties do gradually improve as polydispersity decreases. At a high polydispersity, the mechanical properties of P(i)+P(j) can even be distinctly reduced relative to P(i), in particular the breaking elongation and impact strength. Therefore, the polydispersity for linear P(j) measures <5, preferably <4, more preferably <2, and most preferably <1.5.

In hyper-branched P(j) with crystallizable side chains, the polydispersity ranges from 3-40, preferably 4-35, more preferably 5-30, and most preferably 6-25. If P(i) is a polyethylene, the mechanical properties of P(i)+P(j) increase in the following sequence of P(j) types: Paraffin waxes, microcrystalline waxes, PE waxes, hyper-branched PE waxes, closely distributed PE waxes.

The suitability of P(j) in the formation of advantageous mixed crystallites with P(i) increases with the relative density of P(j) relative to the density of an ideal crystallite of P(i). For PE, the density of an ideal crystallite measures roughly 0.99 g/cm³. The density of P(j) divided by the density of an ideal crystallite of P(i) measures >0.9, preferably >0.93, more preferably >0.945, and most preferably >0.96 for applications where the mechanical properties of P(i)+P(j) are comparable to P(i), and >0.95, preferably >0.96, more preferably >0.97, and most preferably >0.98 for applications where the mechanical properties of P(i)+P(j) relative to P(i) are improved.

It was further found that a percentage of P(j) with a polymerization degree <12 has a negative effect on the mechanical properties of P(i)+P(j). This has to do with the fact that these small molecules can rapidly diffuse, and facilitate the formation of separate phases of P(j). Therefore, the percentage of P(j) at a polymerization degree of <12 in a preferred embodiment in % w/w is <20, preferably <15, more preferably <10, and most preferably <5. The percentage of P(j) with a polymerization degree of <10 in % w/w is <15, preferably <10, more preferably <5, and most preferably <3. The percentage of P(j) with a polymerization degree of <8 in % w/w is <10, preferably <5, more preferably <2.5, and most preferably <1.5.

Another property of P(j) with a polydispersity of >1.5 that correlates positively with the mechanical properties of P(i)+P(j) is the relative melting or dripping point. In a preferred embodiment, the melting or dripping point of P(j) in ° C. divided by the melting point of an ideal crystallite of P(i) in ° C. is >0.73, preferably >0.8, more preferably >0.88, and most preferably >0.91. The melting point of an ideal crystallite of PE lies at roughly 137° C. At a polydispersity of <1.5, a clearly lower dependence was found to exist between the mechanical properties of P(i)+P(j) and the melting or dripping point of P(i).

In more or less linear P(j), it was found that short-chain branches with a polymerization degree of <12, in particular <10, negatively influence the synergistic effects of P(i) and P(j), and hence the mechanical properties. In a preferred embodiment, the percentage of such short-chain branches of P(j) hence lies at <0.05, preferably <0.01, more preferably <0.005, and most preferably <0.001. The reason is that such short-chain branches impede crystallization, since they cannot be regularly incorporated into the crystallite.

By contrast, a percentage of such branches has a positive impact on the mechanical properties in long-chain branches of P(j) with a polymerization degree of >15, preferably >20, since this makes it possible to incorporate different segments of P(j) into various crystallites, thereby enabling an additional linkage of crystallites.

The viscosity of P(j) is here one significant variable for P(j) with respect to maximizing the MFI of P(i) and P(j). The lower the viscosity of P(j), the greater the increase in the MFI of P(i)+P(j) given the same percentage of P(j). FIG. 2 shows the correlation for a typical injection molding LDPE. The higher the set MFI can be set, the shorter the cycle times possible for injection molding, as evident from FIG. 2. For this reason, the viscosity for P(j) at 150° in cP in a preferred embodiment measures <50,000, preferably <1,000, more preferably <500, and most preferably <250. On the other hand, the possibility of separating P(i) and P(j) increases as viscosity decreases, so that the synergistic effects can not be utilized. In a preferred embodiment, the viscosity of P(j) at 150° C. in cP is hence >4, preferably >12, more preferably >15, and most preferably >20. The above data provides for a very wide range of viscosity for P(j). It must here be remembered that the melting viscosity of P(i) lies at 1,000,000 cP or more, and the MFI decreases at a constant percentage of P(j) with the logarithm for the viscosity of P(j), so that a high viscosity of 25,000 cP still enables a considerable increase in the MFI for P(i)+P(j). The selection of viscosity for P(j) also depends on the used percentage of P(j) and the injection molding part. At percentages of up to approx. 7% and at high cooling rates of the kind encountered for thin-walled injection-molded parts, P(j) with very low viscosities can also be used, without separation taking place. The higher viscous P(j) are increasingly being used at high percentages. In a homologous series of linear P(j), the viscosity does not increase linearly, but steadily, with molecular weight. However, branched and in particular hyper-branched P(j) have comparably lower viscosities. This is an advantage when using such P(j).

Optimization capabilities are also provided in particular through the of various types of P(j).

At a molecular weight of <600 g/mol of P(j), the percentage of P(j) in % w/w measures >3, preferably >5, more preferably >7, and most preferably >9. As the percentage rises, the extent of cycle time reduction increases rapidly. At a molecular weight of <600 g/mol of P(j), the maximum percentage of P(j) in % w/w measures <30, preferably <25, more preferably <22, and most preferably <17. At excessive percentages, there may be a reduction in breaking elongation and impact strength, in particular in thick-walled injection-molded parts and in HDPE, while the modulus of elasticity and yield point are hardly diminished for HDPE, and in most cases lie above the values of P(i) here as well.

At a molecular weight of 600-1000 g/mol of P(j), the minimal percentage of P(j) in % w/w measures >3, preferably >6, more preferably >8, and most preferably >10, while the maximal percentage measures <33, preferably <28, more preferably <242, and most preferably <20. At a molecular weight of >1000 g/mol, the minimal percentage of P(j) in % w/w measures >3, preferably >7, more preferably >10, and most preferably >12, while the maximal percentage in % w/w measures <37%, preferably <33, more preferably <28, and most preferably <24. The higher the molecular weight of P(j), the more stable the molecularly disperse mixture of P(i)+P(j) with respect to separation, so that higher percentages can be used without diminishing the mechanical properties, while the increase in MFI is less pronounced, so that the minimal percentages are also comparably higher.

### Mechanical Properties

The aforementioned impact strength, which can be measured on samples taken from films. However, it is not stress emanating from the impact energy reflecting this impact strength that results in failure in injection-molded parts. Rather, failure occurs at a far lower impact energy owing to frozen-in stresses and inner inhomogeneities. Such inhomogeneities come about when polymer streams in the injection-molded part encounter each other, and do not bond optimally. Increasing the MFI and improving the flow characteristics lessens these inner inhomogeneities, or can even eliminate them entirely, as well as reduce inner stresses. This markedly improves the impact strength of the injection-molded part. In terms of the impact strength measured for pressed or extruded films, this means that a roughly 50% reduction in impact strength accompanied by an at least 50% increase in the MFI does not yet produce a decrease in impact strength on the injection-molded part. On the other hand, a constant impact strength for film samples given an at least 50% increase in the MFI is tantamount to an impact strength for the injection-molded part elevated by at least 50%.

Mixing in low-molecular components usually has a negative effect on breaking elongation, which already tangibly decreases at several % of low-molecular component. The situation is even more pronounced with respect to impact strength. The fact that this material property of importance for many applications can be maintained or even improved stems from the fact that the low-molecular component has been incorporated into the macromolecular network.

The extent of the increase in modulus of elasticity and yield point depends heavily on density, and hence on the crystallinity of P(i). The modulus of elasticity increases with roughly 5% per 1% of P(j) for LDPE, so that the modulus of elasticity can be doubled at 20% P(j), which translates into an extraordinary added improvement. The yield point increases by roughly 3% per 1% P(j), so that the yield point rises by 60% at 20% P(j), also a very high number. The breaking elongation increases up to about 10% P(j), then peaks at a 10% increase, and finally tapers off slowly, until the initial breaking elongation is again reached at about 15%. By comparison to HDPE, LDPE exhibits a distinctly higher impact strength, so that this property is less important for LDPE. The course of impact strength as a function of P(j) percentage in film samples is similar to that for breaking elongation, wherein the maximum at roughly 10% P(j) reflects an increase of roughly 20%. However, the gain in impact strength for injection-molded parts is clearly higher than for films.

Increases in modulus of elasticity and yield point are less pronounced for HDPE than for LDPE. The modulus of elasticity can be improved by roughly 30%, and the yield point by roughly 15%, while breaking elongation and impact strength are hardly affected in film samples, wherein this corresponds to an improvement of roughly 50% in injection-molded samples.

The distinct rise in stress cracking resistance when adding P(j) is remarkable. By comparison to P(i) without a percentage of P(j), up to 2.5 times the increase was found for HDPE, while this factor was up to 2.1 times for LDPE. The reason for this on the one hand is that the internal stresses frozen in as the result of improved flowability are reduced, and on the other hand that, as known, chemical cross-linking for PE can improve stress cracking resistance, while physical cross-linking increases for P(i)+P(j).

The cited improvements depend heavily on the used P(j) and its percentage. The cited improvements each relate to an optimal selection of these parameters. With respect to the type of P(j), the structural and property variables cited as preferred in the description of P(j) were established with an eye toward optimal performance in terms of the mechanical properties and cycle time reduction.

In a preferred embodiment, in which the processing conditions for P(i) and P(i)+P(j) are comparable, the quotient of the modulus of elasticity E(i,j) for P(i)+P(j) and the modulus of elasticity E(i) of P(i), E(i,j)/E(i) lies at >1, preferably >1.2, more preferably >1.3, and most preferably >1.5; the maximum quotient measures roughly 3.

In a preferred embodiment, in which the processing conditions for P(i) and P(i)+P(j) are comparable, the quotient of the yield point Sy(i,j) for P(i)+P(j) and the yield point Sy (i) of P(i), Sy(i,j)/Sy(i) lies at >1, preferably >1.15, more preferably >1.25, and most preferably >1.35; the maximum quotient measures roughly 1.7.

In a preferred embodiment, in which the processing conditions for P(i) and P(i)+P(j) are comparable, the quotient of the impact strength J(i,j) for P(i)+P(j) and the impact strength J (i) of P(i), J(i,j)/J(i) for the injection-molded part lies at >1, preferably >1.2, more preferably >1.3, and most preferably >1.5; the maximum quotient measures roughly 2.

### Mixing Processes

To allow P(i) and P(j) to form advantageous networks during heterocrystallization, manufacturing a melt in which the components are molecularly dispersed is a necessary precondition. Since P(i) and P(j) in a melted state exhibit extremely disparate viscosities, wherein P(i) typically forms a highly viscous thermoplastic melt, and P(j) is present with a viscosity on a par with water, manufacturing a molecularly disperse mixture of these components is problematical. If the mixture is inadequate, the advantages associated with combining P(i) and P(j) are only partially realized, if at all. In particular, separate phases arise that massively reduce properties such as breaking elongation and impact strength.

The polymers P(i) and P(j) are typically present in the form of powder or granules. If these components are together sent to thermoplastic processing, e.g., via extrusion, P(j) usually melts first, giving rise to a low-viscosity liquid comparable to melted candle wax. On the other hand, P(i) also requires shearing forces for the melting process, wherein mechanical energy is converted into thermal energy, thereby yielding a high-viscous thermoplastic melt. If P(i) and P(j) are made to undergo the mixing process together, the low-viscosity P(j) forms a film around the granules or powder particles of P(i), so that hardly any more shearing forces can be conveyed to P(i) anymore. This problem is more serious when using granules than powder, and in both cases increases with the percentage of P(i).

Since injection-molding extruders are generally single-screw extruders, and most often exhibit limited mixing capabilities, a molecularly disperse mixture of P(i)+P(j) can be manufactured in one of the following ways:

1. At contents of P(j) of up to roughly 3%, P(i) and P(j) can be mixed together in granule or powder form, e.g., with a tumble mixer, and the two components are then together metered into the injection molding extruder. In one variation, the two components are separately metered into the feed zone in the correct ratio via two metering devices. At low contents of P(j), it is also advantageous for the injection-molding extruder to be equipped with a mixing component, e.g., a Madoc element.

2. At contents of P(j) of >roughly 3%, a first portion of P(j) can be used to proceed according to variation 1, thereby reducing the viscosity of the melt, and making it easier to mix in the second portion. The second portion is then mixed in via a separate metering step in a casing section of the extruder, which at least partially already exhibits a thermoplastic melt. The mixture can subsequently be mixed until molecularly disperse using a mixing component, if necessary a second mixing component.

3. At all contents of P(j), in particular at contents >7%, P(j) can be introduced into the injection molding extruder by way of a pre-blend or master batch. The pre-blend can be mixed with P(i) in the form of granules or powder, and relayed thus to the injection molding extruder, or P(i) and the pre-blend are metered into the feed zone of the injection molding extruder in two separate metering steps, or the pre-blend first passes the feed zone of P(i) and then enters a casing, wherein P(i) is present in an at least partially plasticized state. Configuring the injection molding extruder with one or more mixing components is also advantageous in this 3^{rd} variation.

The manufacture of a molecularly disperse pre-blend, which can exhibit very high contents of P(j), requires special extruder configurations with mixing elements that exert a dispersive and distributive action. While single-screw extruders with mixing components can be used, two-screw extruders having screw configurations that exhibit kneading blocks and/or recirculating elements are preferred. Given a sufficient number of mixing elements, P(i) and P(j) can be processed as described in variation 1. As the percentage of P(j) increases, variation 2 is preferably used for processing. In order to maintain an established molecularly disperse mixture, high cooling rates are necessary, e.g., those encountered during strand extrusion in water.

At high percentages of P(j), especially when P(i) already has an high MFI, pre-blends exhibit an unusually low viscosity for polymer melts, so that special granulation techniques are used for low and super-low viscosity polymer melts, e.g., underwater granulation, underwater strand granulation or dripping processes, in particular dripping in water.

4. Different combinations of the above 3 variations can also be used. In particular at high percentages of P(j) measuring >14%, it can make sense to use variation 1 for the first portion of P(j), and variation 3 for the second portion.

Of the different variations, number 3 is the most interesting in terms of efficiency, in particular at higher percentages of P(j), since the pre-blend is manufactured independently of the injection-molding process, and adjusting the injection-molding process hence requires fewer modifications. A single large facility for manufacturing pre-blends can then service a plurality of injection molding extruders. Such pre-blends can have up to 85% P(j).

The polymer mixture according to the invention is suitable for manufacturing an object, wherein a first synthetic polymer P(i) and a second synthetic polymer (P(j) are converted into a melted state, the two melted polymers P(i) and P(j) are mixed until molecularly disperse, and the molecularly disperse mixture is portioned and cooled, so as to obtain the solidified object from the polymer mixture. To manufacture injection-molded parts from the polymer mixture, portioning and cooling are here accomplished by injecting the molecularly disperse mixture into a cooled or heated injection mold.

However, granule particles can also be fabricated from the polymer mixture. This yields the pre-blends or master batches discussed further above in the form of loose material with a high content of P(j). The melt is here portioned and cooled via granulation in a cooling medium, in particular via strand granulation in a cooling liquid (e.g., water), or via dripping the melt using a possibly vibrating die plate in a cooling fluid. The cooling fluid can be nitrogen, air or another inert gas, if necessary mixed in with an atomized cooling liquid (e.g., water). As an alternative, the melt can also be directly dripped into a standing or preferably streaming cooling liquid.

### Applications

Polymer mixtures according to the invention can be used in all areas pertaining to injection molded articles. For example, in packaging, consumer goods, building and construction, as well as transport and logistics. Examples of these areas include tanks, containers, buckets, boxes, bottle containers, seals, palettes, performs, furniture, garden furniture, casings, device casings, machine tools, toothed wheels, medical products, precision parts, CD's, toys. This list is not to be construed as limiting.

### EXAMPLES

The following illustrative examples are not to be construed as limiting.

### Example 1

This example shows the influence that different percentages of P(j) have on the MFI of various mixtures of P(i) and P(j), wherein diverse polyethylenes are used for P(i).

An opposed, tightly meshing Collin extruder ZK 50/12 D with 12 L/D and D=50 mm was used for P(i) to extrude a range of 10 different LDPE and HDPE lupolenes with MFI's ranging from 0.1 to 20 g/10 min at 80 RPM and 4 kg/h, wherein the plasticization of P(i) was ensured via a dispersing disk in the second zone, after which PE wax granules with a viscosity at 150° C. of 4 cP, a molecular weight of roughly 500 g/mol and a polydispersity of 1.1 was metered into the third zone as the low-molecular component (P(j). A second dispersing disk was then used in the fourth zone to obtain a molecularly disperse mixture of P(i)+P(j), and extrude it as a strand through a perforated die. The feed zone was set to 40° C., zones 2 to 4, along with the adapter and die, were set to 200° C. for polymers with a high MFI, and to 230° C. for polymers with a low MFI. The strand was cooled with water and comminuted into granules, so that 3 MFI measurements were performed at 180° C. and 3.8 kg.

FIG. 1 shows the progression of the MFI for P(i)+P(j) as a function of the percentage of P(j), wherein the top and bottom curve indicate the scatter band that encompasses the measured values obtained for different PE's. The middle curve indicates the average progression. As evident, the increase in the MFI is linear and then disproportionately high at contents of P(j) ranging from 10 to 15%. However, the MFI increase is already massive in the linear range, so that the cycle times can already be tangibly reduced in this area, as shown by a comparison with FIG. 2.

### Example 2

This example shows the influence exerted by the viscosity of P(j) and the percentage of P(j) on the MFI for P(i)+P(i).

The same process as in Example 1 was used to fabricate mixtures of an LDPE with a high MFI at 180° C. and 3.8 kg of 9.6 g/10 min, with 3, 10 and 20% of a range of P(j) having viscosities at 150° C. ranging from 4 to 25,000 cP, after which they were granulated, and the MFI thereof was measured at 180° C. and 3.8 kg. Paraffin, Fischer-Tropsch waxes, microcrystalline waxes and PE waxes were used as the low-molecular components. Primarily the viscosities of P(j) are relevant with respect to the MFI, with the specific structural parameters of great importance for the mechanical properties of P(i)+P(j) playing a subordinate role here. FIG. 3 shows the progression followed by the increase in the MFI for P(i)+P(j) relative to the MFI for P(i) with increasing viscosity of P(j) for percentages of P(j) ranging from 1 to 20%. For the sake of clarity, the measured points are only plotted for 10% P(j). The curves for percentages other than 3, 10 and 20% were obtained through interpolation.

### Example 3

This example shows the influence exerted by narrowly distributed PE waxes with varying molecular weight on the material properties of mixtures of these PE waxes with a typical injection molded HDPE within a range of cooling rates of the kind employed for injection molding.

The same process as in Example 1 was used to fabricate mixtures of an HDPE with a high MFI at 180° C. and 3.8 kg of 9.4 g/10 min with 0, as well as 7 and 14% of three completely linear PE waxes with polydispersities of 1.1. The molecular weights of the waxes, their polymerization degree, densities and viscosities at 150° C. were as follows: PE wax 1: 500 g/mol, 18, 0.93 g/cm³, 4 cP; PE wax 2: 1000 g/mol, 36, 0.96 g/cm³, 12, cP; PE wax 3: 3000 g/mol, 107, 98 g/cm³, 130 cP. Roughly 11 g of the polymer mixtures were accumulated on a plate with 180° C. during a respective 10 seconds on the die, and immediately pressed into a film with a thickness of 0.3 mm at 180° C. The following pressing and cooling conditions were then applied for each polymer mixture.

Cooling 1.0: Storage for 30 seconds in the press at 180° C., followed by transfer of molding into a furnace at 80° C., and storage therein for 3 minutes, after which cooling to room temperature in the atmosphere.

Cooling 1.2: Storage for 30 seconds in the press at 180° C., followed by cooling in the atmosphere.

Cooling 1.5: Storage for 30 seconds in the press at 180° C., followed by transfer of molding into a water bath at 70° C., and storage therein for 3 minutes, after which cooling to room temperature in the atmosphere.

Cooling 1.8: Storage for 3 minutes in the press at 180° C., followed by transfer of molding into a water bath at 16° C.

Cooling 1.9: Storage for 1.5 minutes in the press at 180° C., followed by transfer of molding into a water bath at 16° C.

Cooling 2.0: Storage for 30 seconds in the press at 180° C., followed by transfer of molding into a water bath at 16° C.

The cooling rates for the different treatments were about as follows: 1.0: 5° C./min; 1.2: 20° C./min; 1.5: 20° C./sec; 1.8: 50° C./sec; 1.9: 50° C./sec; 2.0: 50° C./sec. Cooling processes 1.8, 1.9 and 2.0 were used to examine potential separations. All told, the studied cooling processes encompass the entire range of cooling rates used for injection-molded parts. It must here be remembered that the cooling rates can vary within very broad limits for an injection-molded part. In a thick-walled injection-molded part, for example, a cooling corresponding to 1.8 to 2.0 can take place, while it reflects 1.0 to 1.2 in the center.

FIG. 4 shows the moduli of elasticity for the different recipes in the diverse cooling processes. Higher moduli of elasticity were obtained in all cases except for PE wax 1 with the lowest molecular weight and slowest cooling rates. This can be attributed to the synergistic interaction between P(i) and P(j), and to the improved crystallizability owing to the percentage of P(j). For wax 1, the modulus of elasticity is higher at 7% than at 14%, since a partial separation can take place at 14%. In the other waxes, the situation is reversed, since separation is hampered here as the result of the distinctly higher molecular weight, but still takes place to a slight extent, as denoted by the curve progression in the area of cooling processes 1.8 to 2.0, but without actually having a negative effect on the properties, since the values are always still just higher than for the reference curve with 0% wax. The behavior of the yield point is similar to the behavior of the modulus of elasticity.

FIG. 5 shows the breaking elongations. Here as well, the reduced breaking elongations at 14% wax reveal the facilitated separation at a low molecular weight of P(j). All other measured values are roughly comparable to the reference curve with 0% wax. This is surprising, since breaking elongation normally reacts sensitively to low-molecular additives.

FIG. 6 shows the impact strengths. This property reacts the most sensitively to low-molecular admixtures. Despite this face, identical values could be obtained for PE wax 3 with 3000 g/mol molecular weight with the reference. Only at 14% is a reduction observed, although it is only slight at higher cooling rates. The influence of molecular weight is clearly manifested in the curves for wax 1 and 2.

Injection-molded parts typically exhibit frozen-in stresses, which diminish impact strength. In addition, the locations in injection-molded parts where polymer streams come into contact with each other represent special weak points with respect to viscosity, since the bond is not optimal. Increasing the MFI by adding P(j) can ameliorate these two problems, thereby improving the viscosity. For this reason, a reduced viscosity on FIG. 6 will still be higher in an injection-molded part than the viscosity given 0% wax.

### Analyses

The MFI measurements were performed with a type 4106.1 Zwick MFI tester.

The tensile tests were performed at 22° C. with an Instron 4502 tensile testing machine at a transverse velocity of 100 mm/min on standardized tensile samples according to DIN 53504 S3, which were stamped out of 0.3 mm thick films. The measured results are the averaged values of a respective 5 individual measurements.

The impact strength or impact energy was determined using the Izod Impact method with a Frank impact tester at a pendulum of 1 joule. Film samples 5 mm wide and 0.3 mm thick were used as the sample bodies. The length of the samples between the two clamps was 40 mm.

The stress cracking resistance was determined according to AST D-1693 under conditions B (50° C., 100% Igepal CO-630) on the bent strip, wherein the time after which 50% of the samples had failed was determined.

### DESCRIPTION OF FIGURES

FIG. 1 shows the influence of the content of P(j) on the MFI of the mixture of P(i) and P(j);

FIG. 2 shows the influence of the increase in MFI on the reduction in cycle time;

FIG. 3 shows the influence of viscosity and the percentage of P(j) on the MFI of the mixture of P(i) and P(j);

FIG. 4 shows the influence of various narrowly distributed PE waxes on the modulus of elasticity;

FIG. 5 shows the influence of various narrowly distributed PE waxes on the breaking elongation;

FIG. 6 shows the influence of various narrowly distributed PE waxes on the impact strength.

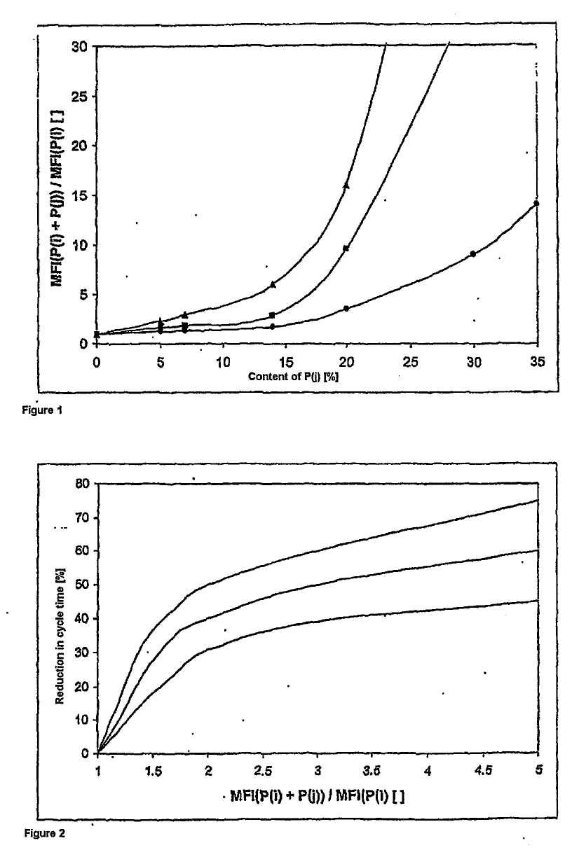

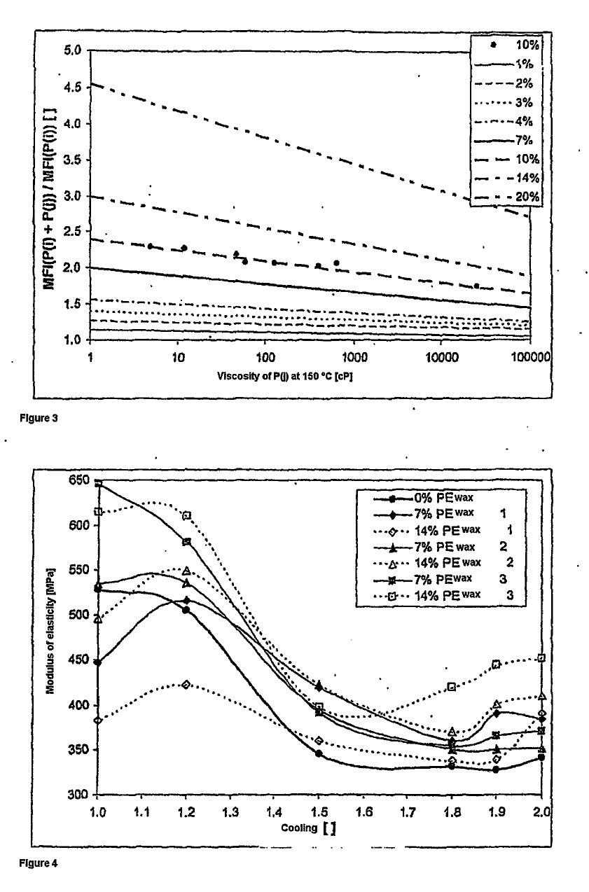

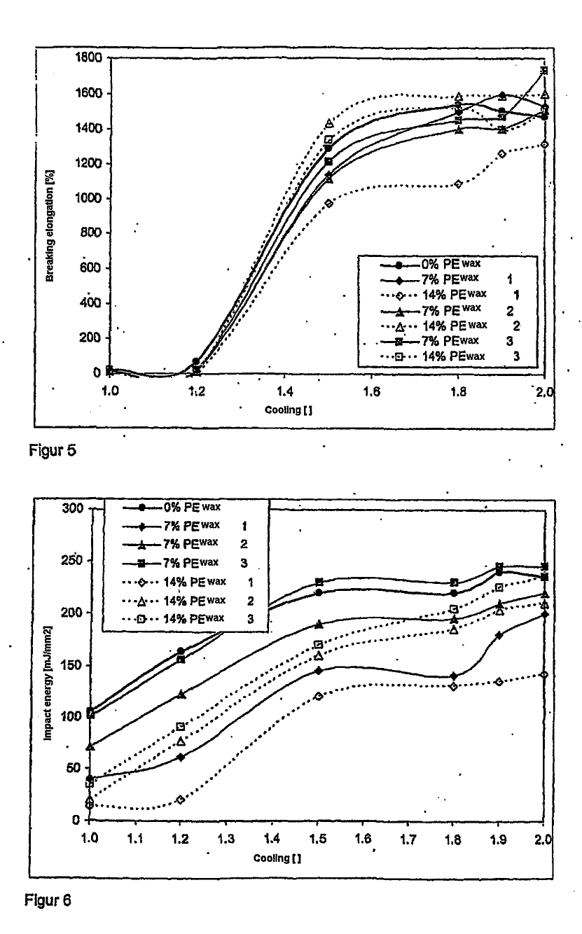

1-12. (canceled)

13. Molded part comprised of a polymer mixture, wherein a) the polymer mixture exhibits a synthetic first polymer P(i) and at least a second synthetic polymer P(j), that b) polymer P(i) exhibits a polymerization degree DP(P(i))>400 and at least one type of crystallizable sequences A with a polymerization degree DPs(P(i)) of these sequences of >15, that c) the polymer P(j) consists of the same monomer units as the sequences A of P(i), the polymerization degree DP(P(j)) of P(j) is <400, that d) the polymer mixture is mixed in a molecularly disperse manner, and a phase separation of the two polymers P(i) and P(j) is suppressed, and that e) the polymer mixture is shaped into a molded part by means of an injection molding process, wherein f) a network is formed during the solidification of the polymer mixture during heterocrystallization, characterized in that g) the percentage of p(j) at a polymerization degree of <12 in % w/w is <20.

14. The molded part according to claim 13, characterized in that the polymer P(j) is linear and exhibits a percentage of short-chain branches of <0.05.

15. The molded part according to claim 13, characterized in that P(j) is branched and exhibits long-chain branches with a polymerization degree of >15.

16. The molded part according to claim 13, characterized in that P(j) is linear and exhibits a polydispersity of <5.

17. The molded part according to claim 13, characterized in that the percentage of P(j) with a polymerization degree of <12 in % w/w is 20.

18. The molded part according to claim 13, characterized in that the percentage of P(j) in % w/w ranges from 1 to 40%.

19. The molded part according to claim 13, characterized in that, at comparable processing conditions for P(i) and P(i)+P(j), the quotient of the modulus of elasticity E(i,j) for P(i)+P(j) and the modulus of elasticity E(i) of P(i), E(i,j)/E(i) ranges between 1 and 3.

20. The molded part according to claim 13, characterized in that P(i) or sequences A of P(i) are selected from the following group: PET, PUR, ABS, PVC and polyolefins.

21. The molded part according to claim 13, characterized in that P(i) is a polyolefin, and P(j) is selected from the following group: n-alkanes CₙH_{2n|2}, iso-alkanes Cₙ; cyclic alkanes CₙH₂ₙ; polyethylene waxes; paraffins and paraffin waxes of mineral origin, such as macrocrystalline, intermediate or microcrystalline paraffins, brittle, ductile, elastic or plastic microcrystalline paraffin; paraffins and paraffin waxes of a synthetic origin; hyper-branched alpha olefins; and polypropylene waxes.

22. A method for manufacturing a molded part out of a polymer mixture according to claim 13, characterized in that the process involves the following steps: A) conversion of a first synthetic polymer P(i) and a second polymer P(j) into a melted state, B) molecularly disperse mixing of both melted polymers P(i) and P(j), and C) portioning and cooling of the molecular disperse mixture to obtain the solidified object from the polymer mixture.

23. The method according to claim 22, characterized in that the molded article is an injection-molded part, wherein portioning and cooling take place by injecting the molecularly disperse mixture into an injection mold.

24. The method according to claim 22, characterized in that the cycle time during the injection molding process with this polymer mixture is reduced by >7% by comparison with the cycle time of P(i) without a percentage of P(j).

25. The molded part according to claim 13, wherein the polymer mixture further exhibits a swelling agent for at least one of P(i) and P(j).

26. The molded part according to claim 13, characterized in that P(i) or sequence A of P(i) are selected from the group consisting of PE and PP.

27. The method according to claim 22, characterized in that the object is a granulate, and wherein portioning and cooling take place by granulating in a cooling medium.

28. The method according to claim 26, wherein the granulate is a pre-blend.
